(19) United States
(12) Patent Application Publication
(10) Pub. No.: US 2011/0047795 A1
(43) Pub. Date: Mar. 3, 2011

(54) MEDICAL LEADS WITH SEGMENTED ELECTRODES AND METHODS OF FABRICATION THEREOF

(76) Inventors: Kevin Turner, Frisco, TX (US); Don Dye, Plano, TX (US)

(21) Appl. No.: 12/873,838

(22) Filed: Sep. 1, 2010

Related U.S. Application Data
(60) Provisional application No. 61/238,917, filed on Sep. 1, 2009.

(51) Int. Cl. H01R 43/20

(52) U.S. Cl. 29/876

(57) ABSTRACT

In one embodiment, a method of fabricating a segmented electrode stimulation lead for implantation within a human patient for stimulation of tissue of the patient, the method comprises: providing a conductive ring, the conductive ring comprising an inner surface and an outer surface, the conductive ring comprising a plurality of grooves provided in the inner surface; electrically coupling a plurality of wires to the conductive ring; forming a stimulation assembly of the lead including the conductive ring and the plurality of wires; and grinding down the outer surface of the stimulation assembly of the lead at least until reaching the plurality of grooves to separate the conductive ring into a plurality of electrically isolated segmented electrodes.

### CROSS-REFERENCE TO RELATED APPLICATIONS

This application claims the benefit of U.S. Provisional Application No. 61/238,917, filed Sep. 1, 2009, which is incorporated herein by reference.

### TECHNICAL FIELD

This application is generally related to stimulation leads, and in particular to stimulation leads with segmented electrodes and methods of fabrication.

### BACKGROUND INFORMATION

Deep brain stimulation (DBS) refers to the delivery of electrical pulses into one or several specific sites within the brain of a patient to treat various neurological disorders. For example, deep brain stimulation has been proposed as a clinical technique for treatment of chronic pain, essential tremor, Parkinson's disease (PD), dystonia, epilepsy, depression, obsessive-compulsive disorder, and other disorders.

A deep brain stimulation procedure typically involves first obtaining preoperative images of the patient's brain (e.g., using computer tomography (CT) or magnetic resonance imaging (MRI)). Using the preoperative images, the neurosurgeon can select a target region within the brain, an entry point on the patient's skull, and a desired trajectory between the entry point and the target region. In the operating room, the patient is immobilized and the patient's actual physical position is registered with a computer-controlled navigation system. The physician marks the entry point on the patient's skull and drills a burr hole at that location. Stereotactic instrumentation and trajectory guide devices are employed to control the trajectory and positioning of a lead during the surgical procedure in coordination with the navigation system.

Brain anatomy typically requires precise targeting of tissue for stimulation by deep brain stimulation systems. For example, deep brain stimulation for Parkinson's disease commonly targets tissue within or close to the subthalamic nucleus (STN). The STN is a relatively small structure with diverse functions. Stimulation of undesired portions of the STN or immediately surrounding tissue can result in undesired side effects. Mood and behavior dysregulation and other psychiatric effects have been reported from stimulation of the STN in Parkinson's patients.

To avoid undesired side effects in deep brain stimulation, neurologists often attempt to identify a particular electrode for stimulation that only stimulates the neural tissue associated with the symptoms of the underlying disorder while avoiding use of electrodes that stimulate other tissue. Also, neurologists may attempt to control the pulse amplitude, pulse width, and pulse frequency to limit the stimulation field to the desired tissue while avoiding other tissue.

As an improvement over conventional deep brain stimulation leads, leads with segmented electrodes have been proposed. Conventional deep brain stimulation leads include electrodes that fully circumscribe the lead body. Leads with segmented electrodes include electrodes on the lead body that only span a limited angular range of the lead body. The term “segmented electrode” is distinguishable from the term “ring electrode.” As used herein, the term “segmented electrode” refers to an electrode of a group of electrodes that are positioned at the same longitudinal location along the longitudinal axis of a lead and that are angularly positioned about the longitudinal axis so they do not overlap and are electrically isolated from one another. For example, at a given position longitudinally along the lead body, three electrodes can be provided with each electrode covering respective segments of less than 120° about the outer diameter of the lead body. By selecting between such electrodes, the electrical field generated by stimulation pulses can be more precisely controlled and, hence, stimulation of undesired tissue can be more easily avoided.

Implementation of segmented electrodes are difficult due to the size of deep brain stimulation leads. Specifically, the outer diameter of deep brain stimulation leads can be approximately 0.06 inches or less. Fabricating electrodes to occupy a fraction of the outside diameter of the lead body and securing the electrodes to the lead body can be quite challenging.

### SUMMARY

In one embodiment, a method of fabricating a segmented electrode stimulation lead for implantation within a human patient for stimulation of tissue of the patient, the method comprises: providing a conductive ring, the conductive ring comprising an inner surface and an outer surface, the conductive ring comprising a plurality of grooves provided in the inner surface; electrically coupling a plurality of wires to the conductive ring; forming a stimulation assembly of the lead including the conductive ring and the plurality of wires; and grinding down the outer surface of the stimulation assembly of the lead at least until reaching the plurality of grooves to separate the conductive ring into a plurality of electrically isolated segmented electrodes.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIG. 1 depicts a cross-sectional view of a conductive ring for fabrication of a segmented electrode stimulation lead according to one representative embodiment.

FIG. 2 depicts a detailed cross-sectional view of a conductive ring for fabrication of a segmented electrode stimulation lead according to one representative embodiment.

FIG. 3 depicts a side view of a conductive ring for fabrication of a segmented electrode stimulation lead according to one representative embodiment.

FIGS. 4A-4E depict processing of one or more conductive rings to form a stimulation tip assembly according to one representative embodiment.

FIG. 5 depicts a stimulation tip according to one representative embodiment.

FIGS. 6A and 6B depict a splicing tube for splicing of wires of a stimulation lead according to one representative embodiment.

FIG. 7A depicts a stimulation system including a segmented stimulation lead according to one representative embodiment.

FIG. 7B depicts a segmented electrode stimulation lead for use in the system of FIG. 7A that may be fabricated according to embodiments disclosed herein.

FIG. 8 depicts a lead body assembly for attachment to a stimulation tip according to some representative embodiments.

FIG. 9A depicts a ring structure for fabricating segmented electrodes that includes an alignment structure according to one representative embodiment.

FIG. 9B depicts a ring structure and an insulative spacer that include complementary mating structures for fabricating segmented electrodes according to one representative embodiment.

FIG. 9C depicts a ring structure that is inserted molded with a resin material according to one representative embodiment.

FIG. 9D depicts the ring structure of FIG. 9C after machining to include a central aperture according to one representative embodiment.

### DETAILED DESCRIPTION

The present application is generally related to a process for fabricating a stimulation lead comprising multiple segmented electrodes. In one preferred embodiment, the lead is adapted for deep brain stimulation (DBS). In other embodiments, the lead may be employed for any suitable therapy including spinal cord stimulation (SCS), peripheral nerve stimulation, peripheral nerve field stimulation, cortical stimulation, cardiac therapies, ablation therapies, etc.

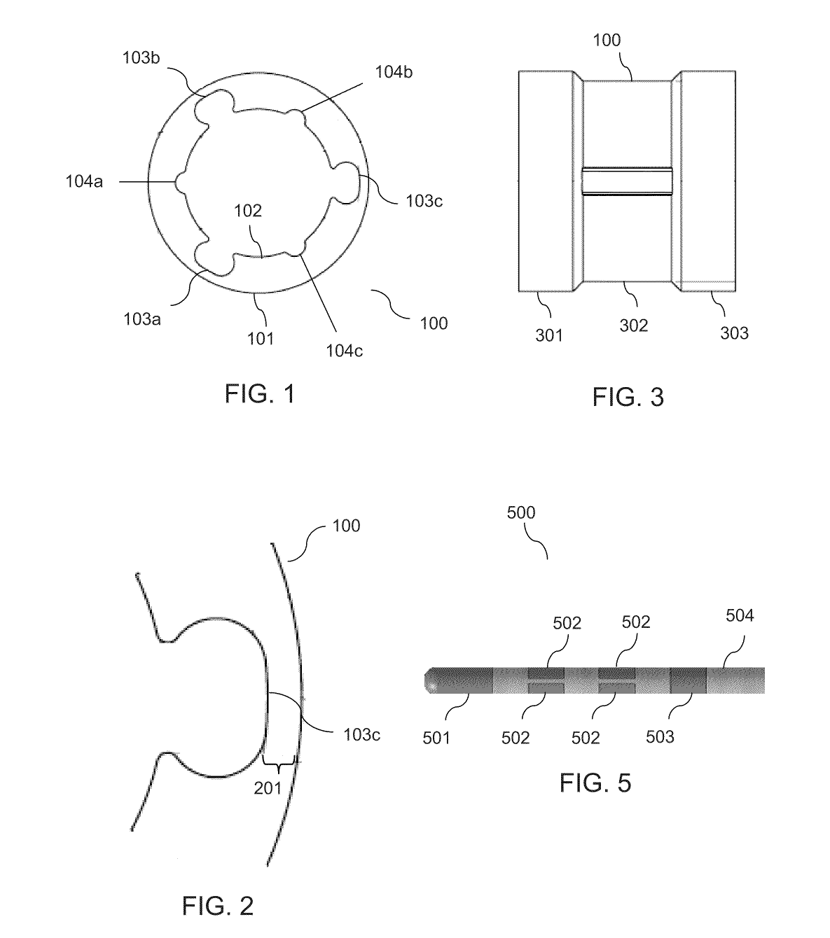

In one embodiment, a ring of conductive material is machined to facilitate the fabrication of segmented electrode lead. As shown in FIGS. 1 and 3, ring 100 is preferably implemented as a continuous or substantially continuous annular tube or cylinder of conductive material. In one embodiment, ring 100 is fabricated from platinum iridium material although any suitable biocompatible, conductive material may be employed.

FIG. 1 depicts a cross-sectional view of ring 100 according to one representative embodiment. Ring 100 comprises an outer surface 101 and an inner surface 102. In one embodiment, ring 100 comprises an inner diameter of 0.041 inches and an outer diameter of approximately 0.061 inches. Using these dimensions, ring 100 comprises a thickness of approximately 0.02 inches. Any suitable dimensions may be provided for ring 100 depending upon the desired stimulation therapy for the fabricated stimulation lead. Also, the dimensions may vary along the length of ring 100 (see discussion of FIG. 3 below) and/or about the circumference of ring 100.

Additionally, ring 100 comprises a plurality of grooves (shown as 103a-103c in FIG. 1) on the inner surface 102 of ring 100. The machined grooves 103 are preferably disposed at equal angular distances from each other along inner surface 102 of ring 100. For example, the center point of each groove may be separated by 120° when ring 100 is intended to be separated into three segmented electrodes.

Grooves 103 are machined into the inner surface 102 of ring 100 to provide a reduction in the thickness of ring 100 at a respective angular portion of ring 100. Machined groove 103c is individually shown in FIG. 2. In one preferred embodiment, groove 103c (and grooves 103a and 103b) reduces the thickness from outer surface 101 to inner surface 102 to approximately 0.005 inches (shown as distance 201 in FIG. 2).

To facilitate the attachment of conductive wires during the lead fabrication process, ring 100 comprises a plurality of channels (shown as 104a-104c in FIG. 1) for receiving a respective wire. The reduction in the wall thickness of ring 100 caused by channels 104 is preferably significantly less than the reduction in wall thickness caused by grooves 103.

FIG. 3 depicts a side view of ring 100 according to one representative embodiment. As shown in FIG. 3, ring comprises distal portion 301, medial portion 302, and distal portion 303. Distal portions 301 and 303 are preferably raised relative to medial portion 302. That is, the outer diameter of ring 100 is greater at distal portions 301 and 303 relative to the outer diameter of ring 100 at medial portion 302.

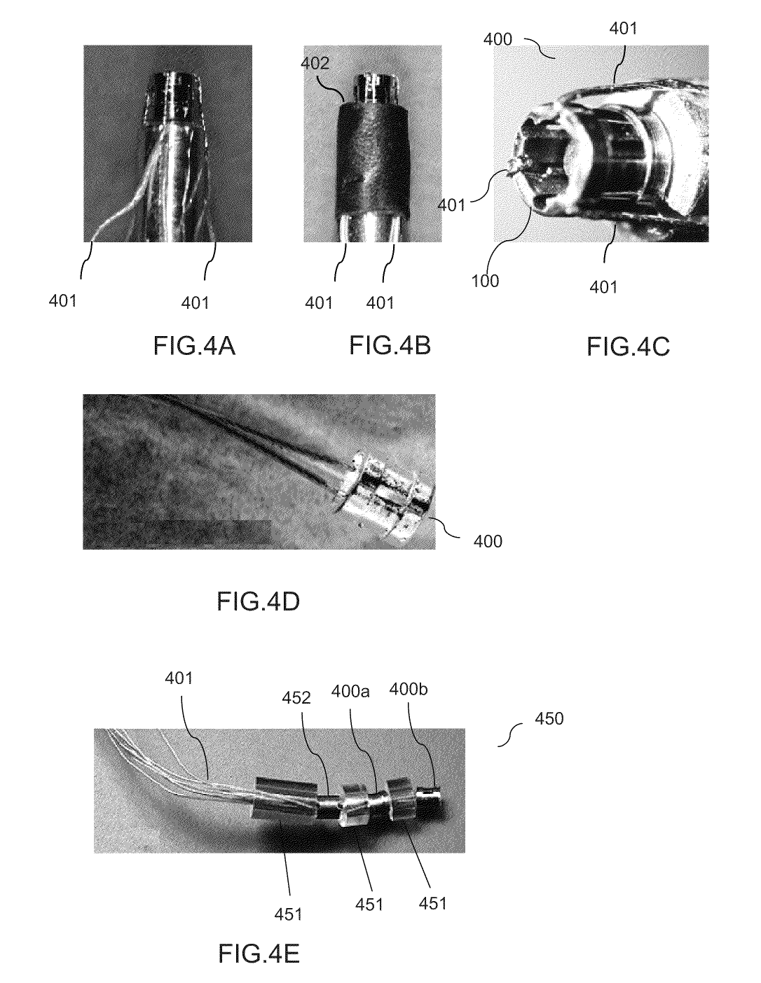

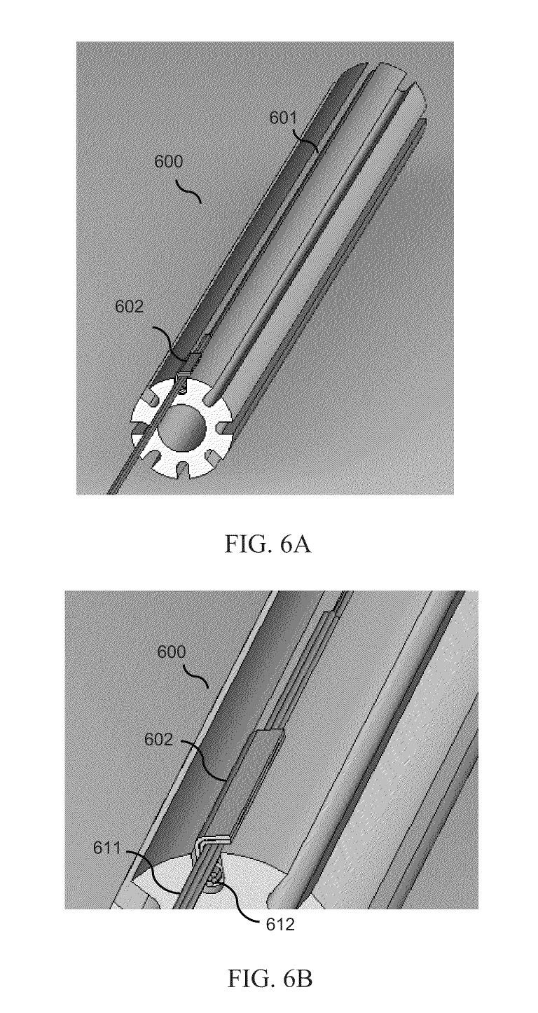

FIGS. 4A-4C depict attachment of conductor wires 401 to ring 100 according to one representative embodiment. During a first step of the wire attachment process, conductor wires 401 and ring 100 are placed onto a welding mandrel as shown in FIG. 4A. Preferably, wires 401 are placed within the interior of ring 100 along channels 104 (shown previously in FIG. 1) and bent over the outer surface 101 of ring 100. Conductor wires 401 are held in a secured position using band 402 as shown in FIG. 4B. Laser energy is then applied to each of conductors 401 to laser weld wires 401 to ring 100. The laser welding mechanically and electrically couples the conductors 401 to ring at the respective channels 104. FIG. 4C depicts ring assembly 400 including attached conductors 401 after the welding process is performed according to one representative embodiment. By attaching wires 401 in this manner according to one embodiment, the wire attachment process may provide several advantageous. For example, a direct line of sight is provided for application of the laser energy. Also, a smaller laser spot size than typically used for electrode laser welding processes may be employed. This process also permits visual inspection to identify any potential wire fraying. Further, this process may provide superior weld consistency. FIG. 4D depicts ring assembly 400 after removal from the welding mandrel.

In some embodiments, multiple ring assemblies 400 are placed in sequence to form a stimulation lead. FIG. 4E depicts stimulation tip assembly 450 according to one representative embodiment. Tip assembly 450 comprises two assemblies 400 placed in sequence and separated by spacer 451. Although only two assemblies 400 are shown in FIG. 4E, any suitable number of assemblies 400 could be employed in any suitable configuration or pattern. Spacers 451 are preferably fabricated using a polymer capable of reflow and, most preferably, is the same polymer as used for a lead body of the stimulation lead. Also, as shown in the embodiment of FIG. 4E, conventional ring electrode 452 is separated from one of the assemblies 400 by another spacer 451. A respective wire 401 is electrically and mechanically coupled to ring electrode 452.

Wires 401 are threaded through the interiors of each preceding structure in tip assembly 450. An additional wire may be threaded through the interiors of the structures to accommodate a tip electrode (not shown in FIG. 4E). In some embodiments, assemblies 400, ring electrode 452, spacers 451 are placed about a segment of tubing (not shown). Outer tubing may be placed about the portion of wires 401 extending away from conventional ring electrode 452.

Tip assembly 450 is preferably subjected to injection molding. A tip electrode may also be attached at the distal end of assembly 450. Grinding (e.g., centerless grinding) or any other suitable material removal technique is performed to reduce the outer diameter of the molded assembly.

When the grinding is performed, material along the outer surface of each ring 100 of ring assemblies 450 is removed. The outer diameter of each ring 100 is gradually reduced until the grinding process exposes grooves 103. When grooves 103 are exposed in a respective ring 100, the ring 100 is separated into multiple electrically isolated segments to function as segmented electrodes due to their respective electrical connection to their respective wires 401. As shown, ring 100 is adapted to separate into three segmented electrodes, although similar designs could be employed to contain fewer or more segmented electrodes.

In some representative embodiments, selected structures within assembly 450 may be adapted to ensure that each ring 100 is aligned in substantially the same manner. That is, upon grinding, each segmented electrode will be aligned in a relatively precise angular manner relative to segmented electrodes at other longitudinal locations of the stimulation lead. For example, as shown in FIG. 9A, each ring 900 may comprise ridge 910 for alignment purposes. The ridges 910 may permit visual inspection to determine the alignment. Alternatively, ridges 910 may be attached to a suitable fixture (not shown) to ensure the proper alignment. In another embodiment, each ring 100 and spacer 451 may include complementary mating structures (see, e.g., structure 951 in FIG. 9B) to attach each structure in a predetermined manner. In another embodiment, a rigid resin may be insert molded (shown as material 975 in FIG. 9C) within the inner surface of ring structure 970 for fabrication of segmented electrodes. A center aperture may be then be machined to facilitate provision of conductor wires. The remaining molded material may be left within grooves (as shown in FIG. 9D) to reduce the probability of segment peeling during the grinding process.

FIG. 5 depicts stimulation tip 500 after the removal of material of rings 100 according to one representative embodiment. As shown in FIG. 5, stimulation tip comprises tip electrode 501, segmented electrodes 502, and proximal ring electrode 503. Wires 401, which are electrically coupled to respective ones of tip electrode 501, segmented electrodes 502, and ring electrode 503, are contained with body 504 of insulative material from the tubing and molding. The insulative material may include BIONATE® (thermoplastic polycarbonate urethane), a silicon based material, or any other suitable biocompatible material. As shown in FIG. 5, stimulation tip 500 is then ready to be integrated with other components to form a stimulation lead according to some representative embodiments.

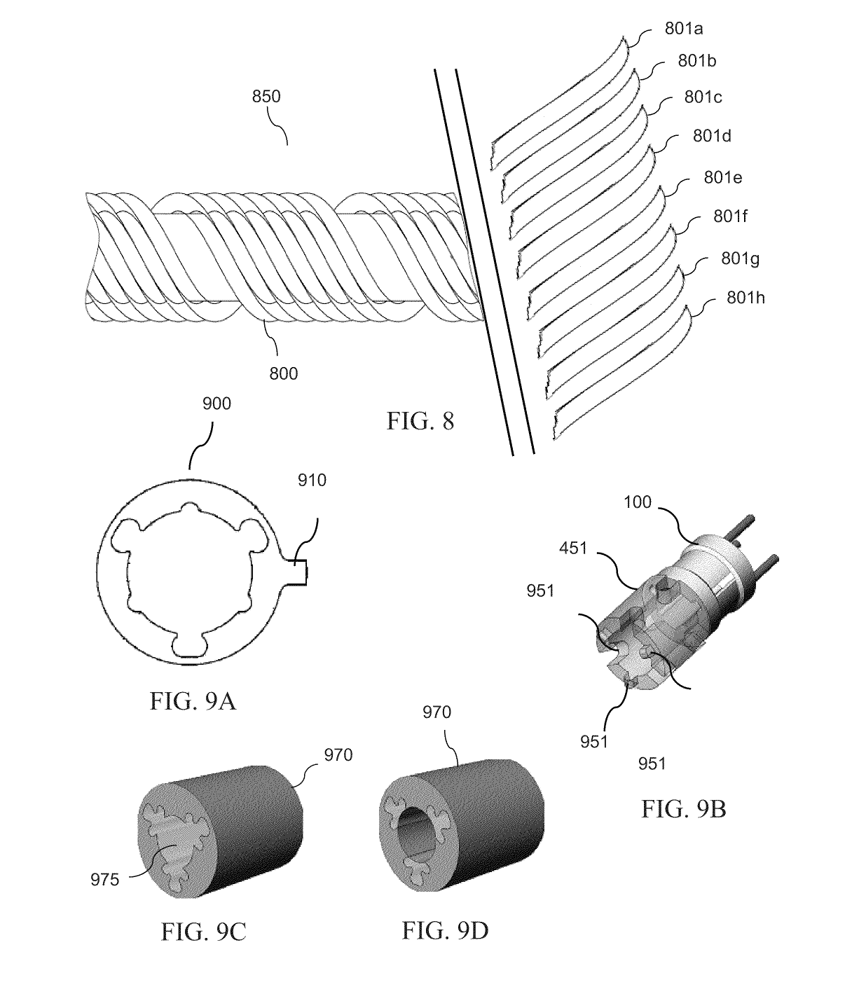

FIG. 8 depicts intermediate lead body assembly 850 adapted for connection to a stimulation tip according to one representative embodiment. Lead body assembly 850 comprises lead body 800 with a suitable number of conductors (shown individually as conductors 801a-801h) embedded or otherwise enclosed within insulative material. Conductors 801 are provided to conduct electrical pulses from the proximal end of lead assembly 850 to the distal end of lead assembly 850. Lead body 800 may be fabricated using any known or later developed processes. Examples of various lead body fabrication processes are disclosed in U.S. Pat. No. 6,216,045, U.S. Pat. No. 7,287,366, U.S. Patent Application Publication No. 20050027340A1, and U.S. Patent Application Publication No. 20070282411A1, which are incorporated herein by reference.

As is known in the art, each individual conductor 801 is commonly provided with a thin coating of a higher durometer insulator such as perfluoroalkoxyethylene (PFA). The purpose of the higher durometer coating is to ensure that the wire within the conductor 801 remains insulated in the event that the softer polymer material of the lead body 800 is breached or otherwise fails while the lead body 800 is implanted within a patient. The conductors 801 are commonly helically wound and insulative material (e.g., a polyurethane, PURSIL®, CARBOSIL®, etc.) is applied over the conductors to hold conductors 801 in place and to support conductors 801. Other common types of lead bodies provide individually coiled conductors within separate lumens of a lead body. Such lead bodies may also be utilized according to some embodiments.

As shown in FIG. 8, the outer insulative material of the lead body 800 is removed at the distal end of lead body 800 to permit access to a length of each conductor 801. For example, a suitable laser (e.g., a UV laser) can be used to remove the insulative material over a controlled portion of the pre-formed lead body 800 to release a length of each conductor 801 from lead body 800. Alternatively, manual stripping may be performed to release each conductor 801. Depending upon the type of harder insulative material applied to each individual conductor 801, a separate process may be used to further expose a conductive portion of the wire of each conductor. Lead body assembly 850 may then be electrically coupled to stimulation tip 500.

FIGS. 6A and 6B depict splicing tube 600 for facilitating splicing of conductors wires during fabrication of a stimulation lead. FIG. 6A depicts a full view of tube 600 and FIG. 6B depicts a detailed view of tube 600 to show conductor detail.

Initially, a lead body is processed to release individual conductors from a distal end of the lead body (see FIG. 8). The released ends of respective conductors from the lead body are placed within grooves of splicing tube 600 (e.g., conductor 612 is shown placed within groove 601 as shown in FIGS. 6A and 6B). The proximal ends of the wires from stimulation tip 500 are also placed within the grooves of splicing tube 600 (e.g., conductor 611 is shown placed over conductor 612 in FIG. 6B).

Conductive filler material 602 is preferably provided for each pair of conductors in the grooves of splicing tube 600. In one embodiment, material 602 is provided in ribbon form about each pair of conductors. Material 602 and the pair of conductors are subjected to laser welding. The welding preferably causes material 602 to flow into the strands of the conductor wires making both a mechanical and electrical connection.

The lead body, the splicing tube, and the electrode array are subjected to overmolding. In one preferred embodiment, the splicing tube is formed of thermoplastic material that flows and fuses with the overmolding material, the material of the lead body, the material of the stimulation tip, etc. Accordingly, upon overmolding, an integrated stimulation lead is formed that is substantially free of gaps and free of weakened transitions between separate non-fused layers of insulative material. Suitable grinding techniques are applied to provide a uniform diameter along the lead.

Terminals, electrical contacts for receiving electrical pulses, (not shown) are then provided on the proximal end where the terminals are electrically coupled to the conductive wires internal to the lead body. The terminals may be provided using any known or later developed fabrication process. An example of the suitable fabrication process is shown in U.S. Pat. No. 6,216,045.

During the foregoing discussion, certain fabrication steps have been discussed in a particular sequence. The sequence discussed herein has been presented for the convenience of the reader. It shall be appreciated that the discussed sequence is not required and any suitable order of fabrication may be performed without departing from the scope of the application. Moreover, certain steps may be performed concurrently or separately. For example, grinding may be applied to certain segments of the lead separately or grinding may be applied simultaneously to multiple segments.

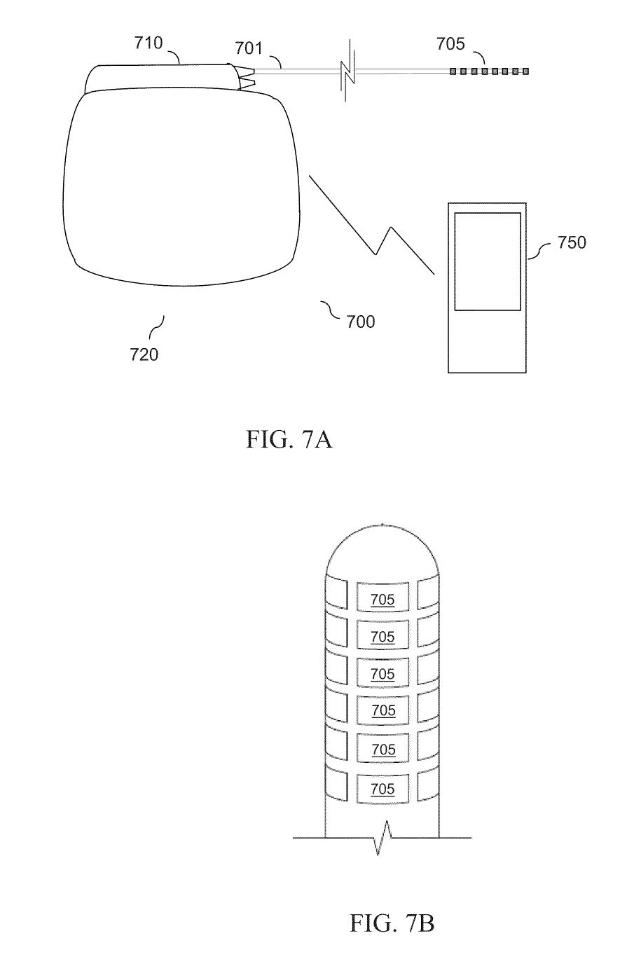

FIG. 7A depicts stimulation system 700 according to one representative embodiment. Neurostimulation system 700 includes pulse generator 720 and one or more stimulation leads 701. Examples of commercially available pulse generator include the EON®, EON MINI®, and the LIBRA® pulse generators available from St. Jude Medical Neuromodulation Division. Pulse generator 720 is typically implemented using a metallic housing that encloses circuitry for generating the electrical pulses for application to neural tissue of the patient. Control circuitry, communication circuitry, and a rechargeable battery (not shown) are also typically included within pulse generator 720. Pulse generator 720 is usually implanted within a subcutaneous pocket created under the skin by a physician.

Lead 701 is electrically coupled to the circuitry within pulse generator 720 using header 710. Lead 701 includes terminals (not shown) that are adapted to electrically connect with electrical connectors (e.g., “Bal-Seal” connectors which are commercially available and widely known) disposed within header 710. The terminals are electrically coupled to conductors (not shown) within the lead body of lead 701. The conductors conduct pulses from the proximal end to the distal end of lead 701. The conductors are also electrically coupled to electrodes 705 to apply the pulses to tissue of the patient. Lead 701 can be utilized for any suitable stimulation therapy. For example, the distal end of lead 701 may be implanted within a deep brain location or a cortical location for stimulation of brain tissue. The distal end of lead 701 may be implanted in a subcutaneous location for stimulation of a peripheral nerve or peripheral nerve fibers. Alternatively, the distal end of lead 701 positioned within the epidural space of a patient. Although some embodiments are adapted for stimulation of neural tissue of the patient, other embodiments may stimulate any suitable tissue of a patient (such as cardiac tissue). An “extension” lead (not shown) may be utilized as an intermediate connector if deemed appropriate by the physician.

Electrodes 705 include multiple segmented electrodes as shown in FIG. 7B. The use of segmented electrodes permits the clinician to more precisely control the electrical field generated by the stimulation pulses and, hence, to more precisely control the stimulation effect in surrounding tissue. Electrodes 705 may also include one or more ring electrodes or a tip electrode (not shown in FIG. 7B). Any of the electrode assemblies and segmented electrodes discussed herein can be used for the fabrication of electrodes 705. Electrodes 705 may be utilized to electrically stimulate any suitable tissue within the body including, but not limited to, brain tissue, tissue of the spinal cord, peripheral nerves or peripheral nerve fibers, digestive tissue, cardiac tissue, etc. Electrodes 705 may also be additionally or alternatively utilized to sense electrical potentials in any suitable tissue within a patient's body.

Pulse generator 720 preferably wirelessly communicates with programmer device 750. Programmer device 750 enables a clinician to control the pulse generating operations of pulse generator 720. The clinician can select electrode combinations, pulse amplitude, pulse width, frequency parameters, and/or the like using the user interface of programmer device 750. The parameters can be defined in terms of “stim sets,” “stimulation programs,” (which are known in the art) or any other suitable format. Programmer device 750 responds by communicating the parameters to pulse generator 720 and pulse generator 720 modifies its operations to generate stimulation pulses according to the communicated parameters.

Although certain representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate when reading the present application, other processes, machines, manufacture, compositions of matter, means, methods, or steps, presently existing or later to be developed that perform substantially the same function or achieve substantially the same result as the described embodiments may be utilized. Accordingly, the appended claims are intended to include within their scope such processes, machines, manufacture, compositions of matter, means, methods, or steps.

What is claimed is:

1. A method of fabricating a segmented electrode stimulation lead for implantation within a human patient for stimulation of tissue of the patient, the method comprising:
providing a conductive ring, the conductive ring comprising an inner surface and an outer surface, the conductive ring comprising a plurality of grooves provided in the inner surface;
electrically coupling a plurality of wires to the conductive ring;
forming a stimulation assembly of the lead including the conductive ring and the plurality of wires; and
grinding down the outer surface of the stimulation assembly of the lead at least until reaching the plurality of grooves to separate the conductive ring into a plurality of electrically isolated segmented electrodes.

2. The method of claim 1 further comprising:
machining the plurality of grooves in a substantially annular ring of metal.

3. The method of claim 1 wherein the conductive ring comprises a medial portion with a reduced outer surface and distal portions at a first end and a second end of the conductive ring with an outer surface greater than the reduced outer surface.

4. The method of claim 1 wherein the conductive ring comprises an alignment structure disposed length-wise along the outer surface of the conductive ring.

5. The method of claim 1 wherein the conductive ring is fabricated from platinum iridium material.

6. The method of claim 1 wherein the electrically coupling comprises:
bending a respective wire over an edge of the conductive ring and into a channel within the conductive ring; and
laser welding the respective wire to the conductive ring.

7. The method of claim 1 wherein the plurality of grooves of the conductive ring are filled with polymer material before the conductive ring is used in the forming of the stimulation assembly.

8. The method of claim 1 wherein the forming comprises:
over-molding the conductive ring and the plurality of wires.

9. The method of claim 8 wherein the over-molding overmolds a biocompatible polycarbonate urethane material over the conductive ring and the plurality of wires.

10. The method of claim 1 further comprising:
electrically coupling the plurality of wires with a second plurality of wires of a lead body.

11. The method of claim 10 wherein the electrically coupling the plurality of wires with a second plurality of wires comprises:
placing the plurality of wires and the second plurality of wires within grooves formed axially along an annular substrate of insulative material.

12. The method of claim 11 wherein the annular substrate is fabricated from a polymer material capable of being placed in a state of flow.
